(19) United States
(12) Patent Application Publication
(10) Pub. No.: US 2017/0313567 A1
(43) Pub. Date: Nov. 2, 2017

(54) BEVERAGE CONTAINER ASSEMBLY FOR HOLDING A BEVERAGE

(71) Applicant: Carlsberg Breweries A/S, Copenhagen V (DK)

(72) Inventors: Jan Norager Rasmussen, Olstykke (DK); Steen Vesborg, Gentofte (DK)

(73) Assignee: Carlsberg Breweries A/S, Copenhagen V (DK)

(21) Appl. No.: 15/526,882

(22) PCT Filed: Nov. 19, 2015
(86) PCT No.: PCT/EP2015/077123

§ 371 Date: May 15, 2017

(30) Foreign Application Priority Data
Nov. 19, 2014 (EP) 14193865.4

(51) Int. Cl. B67D 1/04; B67C 7/00; B29C 49/22; B29B 11/14; B67C 3/22; B29L 31/00

(52) U.S. Cl. CPC B67D 1/0437; B67C 3/22; B67C 7/00; B67D 1/0462; B29C 49/22; B29B 11/14; B29B 2911/14053; B29B 2911/1408; B29B 2911/14533; B67C 2003/227; B29L 2031/712

(57) ABSTRACT

The present invention relates to a beverage container assembly for holding a beverage. The assembly comprises an outer container defining a body portion and a cylindrical neck portion. The cylindrical neck portion defines a rim located opposite the body portion. The beverage container assembly further comprises an inner bag positioned within the outer container and defining a pressure space inside the inner bag and a beverage space between the inner bag and the outer container. The beverage space is filled by beverage and the inner bag initially defines a folded state. By subjecting the inner bag) to a pressure fluid it is capable of expanding into an unfolded state in which the pressure space at least partially substitutes the beverage space. Both the inner bag and the neck portion are sealed off by a cap at a location between the rim and the body portion.

### CROSS-REFERENCE TO RELATED APPLICATIONS

This application is the national phase entry, under 35 U.S.C. Section 371(c), of International Application No. PCT/EP2015/077123, filed Nov. 19, 2015, claiming priority from European Application No. 14193865.4, filed Nov. 19, 2014. The disclosures of the International Application and the European Application from which this application claims priority are incorporated herein by reference in their entireties.

### FEDERALLY SPONSORED RESEARCH OR DEVELOPMENT

Not Applicable

The present invention relates to a beverage container assembly, a preform assembly for manufacturing a beverage container assembly, a method of producing and filling a beverage container assembly and a method of dispensing beverage by providing a beverage container assembly.

### INTRODUCTION

Large-volume carbonated beverages, such as draught beer, are conventionally delivered to the place of consumption in metal kegs that typically hold a large volume of e.g. 25 litres. Such kegs are intended for expensive and elaborate dispensing assemblies comprising draught beer coolers, carbon dioxide cartridges, etc., for cooling and dispensing the beverage from the container. Recently, dispensing assemblies have produced in lighter, more flexible materials. Plastic bags emptied by pressing out the content mechanically, pneumatically or hydraulically have been tested, but are too fragile for most practical purposes. Also dispensing from collapsible beverage bottles made of plastics materials, e.g. PET, are known in the art. These bottles are emptied by collapse of the bottle wall by application of mechanical, pneumatic or hydraulic pressure causing the content to be squeezed out. Such beverage bottles contain only small volumes, such as a few litres, and are not directly comparable to metal kegs, which hold a substantially larger volume of beverage. A dispensing assembly with a collapsible beverage bottle is for example known from EP 1 003 686 A1. This apparatus constitutes an integrated dispensing device comprising a housing with a lid, sealing means, a pressure source, a cooling device and a dispensing tap.

Such dispensing apparatuses have a complicated design, comprising a vast number of parts, the parts themselves being elaborate, costly devices. There is thus a need for providing an assembly for dispensing beverage which has a simple design and construction wherein beverage containers even though being relatively heavy easily may be handled by an user. Furthermore, the market for gourmet-type beverages, such as special kinds of ale, pilsner and stout beers, steadily increases, therefore the demand for these products as draught-beers also increases. This is partly a consequence of the fact that ideal circumstances for such properties as pressure, temperature and foaming are more easily obtained in a draught system as compared to serving beverages from bottles or cans. Thus, to achieve the optimal taste, aroma and texture of e.g. a beer, it is often necessary to serve the beer from a draught system.

As both the number of gourmet beverage products and the customer demand for these products increases, it becomes essential for establishments such as restaurants, bars and pubs to offer a large variety of different beverages at the right quality. Thus, it is becoming increasingly more common for bars and pubs to offer a large number of different quality draught beverages in order to meet the demand of customers.

There is thus a need for providing professionals as well as private people with a large selection of quality beverages. There is also a need for providing these quality beverages in a form, which brings out the best in the beverage and thus ensures high customer satisfaction.

There is furthermore a constant need for reducing the costs of such quality products as well as a need for increasing user-friendliness of systems for dispensing quality beverages.

Often the prior art devices for dispensing beverage have the disadvantage that they need to be set up by professionals for delivering the quality beverage to the customer. The matter is that the beverage often is being dispensed under influence from several exterior parameters such as pressure, gasses, temperatures, etc., which may be impossible for the user of the devices to handle, and in case that the device has been set up wrong, the dispensed beverage will not exhibit the intended quality.

In WO2009/024147, a modular beverage dispensing system is shown in which the dispensing capacity may be expanded or reduced gradually. The system provides multiple pressure chambers which may be selectively interconnected with beverage taps provided on a bar counter. The pressure chambers may be supplied by pressure fluid from a single pressure source, and pressure chambers may without problems be added and removed from the system to adapt the system to the beverage demand which may vary due to seasonal variations etc. However, in order to permanently expand the dispensing capability, such systems will still require investments in the form of additional pressure chambers.

It would thus be an advantage to provide a system which may dispense with the need of a pressure chamber. Such systems typically use a bag-in-container assembly. Some examples of bag-in-container assembly include:

WO 2014/017907 relates to a tapping assembly comprising a first container and a second container suspended in the first container. The first container comprises a neck region having at least one opening in the side wall thereof. A connecting device may be connected to the neck region such that one connecting element of the connection device may connect to the at least one opening and to a source of pressurized gas.

WO 2011/002294 relates to a preform assembly comprising a first preform positioned inside a second preform. In an embodiment the first preform can be provided with at least one and preferably several openings in the neck forming portion. Pressure fluid supplied through the opening thus flows through into the space between the neck portions of the preforms. This will pressurize the inner layer and thus the beverage contained therein, forcing the beverage through the dispense opening in the lid.

Further prior art includes EP 2 148 771 B1, EP 2 152 486 B1, EP 2 148 770 B1 and EP 2 152 494 B1 which all relate to an integrally blow moulded bag-in-container comprising a mouth, an inner layer and an outer layer. The container has at least one vent fluidly connecting the interface between inner and outer layers to the atmosphere. The vent runs parallel to the interface between inner and outer layers and opens to the atmosphere approximately coaxially with the mouth.

Further prior art includes U.S. Pat. No. 7,185,786 B2 relating to a gas adsorption material containing a desired quantity of gas placed in a pressurized container along with a product to be dispensed, and as pressure in the container is depleted during use, stored gas is released into the container to maintain pressure in the container within a predetermined range.

U.S. Pat. No. 5,054,651 relates to a packaging container provided with a distribution valve, a chamber is provided enclosing the starting components of a system for the anaerobic fermentation of sugars using yeasts, which produce the carbon gas forming said propulsive product.

U.S. Pat. No. 4,679,706 relates to a dispensing system for use with a wide variety of dispensable products which employs an inflatable pouch positioned within the container containing a pressurizing gas phase.

The above documents all employ the technology of storing the beverage or fluid product in an inner container while pressurizing the space in-between the inner and outer container, thereby collapsing the inner container and forcing the beverage or fluid product out of the inner container. However, it has been realized by the applicant that the shape of the collapsing inner container will be more or less occasional and thus the dispensation of beverage by collapsing an inner container located within an outer container has the drawback that the collapsing of the inner container in some cases be improper such that the complete dispensation of the beverage or fluid product is hindered. Further, it is difficult for the user to visually determine the remaining amount of beverage in the remaining amount of beverage through multiple container walls. Yet further, after dispensing all of the beverage, the user ends up with a container filled by gas, which constitutes a potential explosion hazard. An explosion of the outer gas filled container would possibly result in injury due to high velocity keg splinters. It is thus an object of the present invention to provide bag-in-keg technologies which allow for a more reliable dispensing of the beverage and provide an easier determination of the remaining amount of beverage in the container, and reduce the risk of explosion.

Another document which is published after the priority date claimed in connection with the present patent application and therefore per se does not form part of the prior art is the international application number EP2014/0600007, the disclosure of which is hereby incorporated in the present specification by reference. This document relates to “a pressurization system for a cylindrical beverage container, the cylindrical beverage container defining a first diameter and having an internal volume including a beverage, the pressurization system comprising:
a cylindrical canister for being positioned within the internal volume, the canister including an adsorption material having an adsorbed specific amount of propellant gas sufficient for replacing the beverage included in the internal volume, the canister including a housing enclosing the adsorption material for preventing contact between the adsorption material and the beverage, and
a bag comprising an inner foil and an outer foil, the inner foil defining an inner upper edge, an opposite inner lower edge, a first side edge and an opposite second side edge welded to the first side edge, the inner foil defining an inner cylinder encircling the canister and defining a second diameter being substantially equal to the first diameter, the outer foil defining an outer upper edge being welded to the inner upper edge forming a common upper edge, an outer lower edge welded to the inner lower edge forming a common lower edge, a third side edge and an opposite fourth side edge welded to the third side edge, the outer foil defining an outer cylinder encircling the inner cylinder, the bag defining an enclosed space between the inner cylinder and the outer cylinder, the bag having a gas inlet providing fluid communication between the canister and the enclosed space, the enclosed space being separated into at least three internal spaces by welds extending partially between the common upper edge and the common lower edge, the bag defining a non-activated state in which the bag is folded about the canister, and an activated state in which the bag is unfolded and filled by the propellant gas.”

The above document concerns a self-contained beverage dispensing system and although as stated above the above document does not per se form part of the prior art it may become relevant in some jurisdictions and thus the applicant reserves the right to disclaim in relation to the present patent application the subject matter disclosed in the above mentioned document and in particular the above cited portion of the above mentioned document.

### SUMMARY OF THE INVENTION

The above advantage, need and object together with numerous other advantages, needs and objects, which will be evident from the below detailed description, are according to a first aspect achieved by a beverage container assembly for holding a beverage, the beverage container assembly comprising:
an outer container defining a body portion and a cylindrical neck portion connected to the body portion, the cylindrical neck portion defining a rim located opposite the body portion,
an inner bag positioned within the outer container and defining a pressure space inside the inner bag and a beverage space between the inner bag and the outer container, the beverage space being filled by the beverage, the inner bag initially defining a folded state in which the inner bag is compressed and by subjecting the inner bag to a pressure fluid the inner bag being capable of expanding into an unfolded state in which the pressure space at least partially substitutes the beverage space, and
a cap sealing off both the inner bag and the neck portion at a location between the rim and the body portion, the cap comprising a beverage passage for establishing fluid communication between the beverage space and the outside of the container assembly.

According to the present technology, the beverage is stored in the space in-between the inner bag and the outer container, and consequently the pressure fluid is stored in the space inside the bag. This constitutes an inverse configuration compared to the prior art. This has the advantage that the bag will be expanding instead of collapsing and thus the behavior of the bag will easier to control. Further, the beverage will be more visible to the user for external observation, since only one container wall will separate the beverage from the user, whereas the beverage will be separated from the user by the bag, a gas space and a container in case the beverage would be located in the inner bag. Thus, the outer container may include a green or brown light absorbing UV protective layer for protecting the beverage similar to a conventional beer bottle while still allowing the beverage to be fully visible.

The outer container should be substantially rigid in order to withstand the pressure required for dispensing. The body portion is typically cylindrical and constitutes the majority of the volume of the outer container. The neck is smaller in volume and constitutes the piece in-between the body portion and the outside of the beverage container. The rim constitutes the dispensing end of the beverage container. Although the container may be made of various materials such a steel, aluminum, copper, wood, glass, etc., it is contemplated that for most practical purposes a polymeric material such as plastics is preferred due to the lightness of such materials and the easy disposal after use.

The inner bag should be flexible in order to be capable of being expanded. The bag is therefore typically made of a polymeric material. It is of course feasible to use an elastic material such as rubber, however, preferably the material is a foldable plastic material. The bag may in some embodiments be made of the same material as the outer container, although no light absorbing layer is required. It may even be made completely transparent or completely opaque. It may be preferred to use a completely gas tight material in order to prevent any gas transport through the inner bag, which may have a negative effect on the taste of the beverage. For instance, a plastic layer coated with a gas impermeable and opaque aluminum layer may be used.

The cap should seal off both the inner bag and the outer container such that any fluid communication between the pressure space inside the inner bag and the beverage space between the inner bag and the outer container is prevented. The cap will essentially seal off both the pressure space and the beverage space and only selectively allow beverage to flow out of the container via the beverage passage. The cap may also allow pressure fluid to flow into the inner bag. Initially, the cap may comprise a rupturable or removable tab which seals off both the pressure space and the beverage space. The cap may be press fitted into the neck adjacent the rim. The cap is preferably made of plastic material just as the rest of the container assembly.

Initially, the beverage space fills most of the outer container and the pressure space is made up of the compressed and folded inner bag adjacent the cap. As the beverage is dispensed via the beverage channel by pressurizing and filling the inner bag, the beverage space becomes smaller and the pressure space increases in volume. At the end of the beverage dispensing operations, the pressure space fills the entire outer container. An ascending pipe may optionally be used for the beverage in order to ensure a complete dispensation of all of the beverage from the container. After all beverage has been dispensed, the pressure in the pressure space may be relieved by means of a safety valve. Notably, the risk of explosion is significantly reduced since both the outer container and the inner bag must rupture for an explosion to take place. Further, in case the inner bag ruptures, the beverage surrounding the bag will dampen the effect of the explosion and reduce the destructive effect of the explosion and reduce the likelihood of the outer container exploding and even in case the outer container would rupture as well as a consequence of the inner bag explosion, the presence of the beverage outside the bag will minimize the velocity of any splinters forming in the explosion.

According to a further embodiment of the first aspect, the inner bag and the outer container are sealed together along the rim of the cylindrical neck. In order for the cap to conveniently seal off both the inner bag and the outer container, and to prevent any leakage between the pressure space and the beverage space, the inner bag and the outer container may be sealed together along the rim of the cylindrical neck. It is contemplated that the inner bag and the outer container are sealed together along the complete circumference of the rim in order to establish a proper seal together with the cap. Press fitting technologies may be used.

According to a further embodiment of the first aspect, the inner bag comprises a beverage conduit located adjacent the neck portion between the rim and the body portion of the outer container for providing fluid communication between the beverage space and the beverage passage. In order to allow the beverage to flow from the beverage space to the outside via the cap, the beverage conduit will provide a fluid passage through the inner bag adjacent the neck and the cap. Thereby, beverage may flow from the beverage space to the beverage passage while maintaining a sealed rim. The cap should still seal the inner bag such that no fluid communication is allowed between the pressure space and the beverage space.

According to a further embodiment of the first aspect, the inner bag comprises a channel extending on the outside of the inner bag between the beverage conduit and the body portion of the container. In order to prevent that the beverage conduit will be blocked by the inner bag at the confined space adjacent the neck, the inner bag may comprise a channel. The channel provides an alternative or supplementary flow path allowing the beverage to pass from the beverage space to the beverage passage in the cap in case the inner bag has expanded adjacent the neck and would otherwise block the beverage passage.

According to a further embodiment of the first aspect, the beverage conduit comprises a plurality of openings of the inner bag, the openings being circumferentially distributed about the inner bag adjacent the neck portion between the rim and the body portion of the outer container. In order increase the amount of beverage capable of flowing through the beverage conduit, the beverage conduit may comprise a plurality of openings, thereby allowing faster dispensing, lower flow velocities and less foaming.

According to a further embodiment of the first aspect, the cap comprises a circumferential groove for providing fluid communication between the beverage conduit and the beverage passage. The groove allows the cap to be inserted into the neck without any concern about the circumferential orientation of the cap, and in particular the beverage passage relative to the beverage conduit. The groove should extend circumferential about the cap and provide a connection between the beverage conduit and the beverage channel in case they are not flush. This has the advantage that the cap will be essentially circular symmetric allowing a random application of the cap, similar to the capping or ordinary bottles with the use of e.g. a classic crown cap.

According to a further embodiment of the first aspect, the outer container and the inner container are integrally blow molded from a preform assembly constituting an inner preform and an outer preform in a nested configuration. In this way both the inner bag and the outer container may be blow moulded in a single integral step. Such integral blow moulding has been described in e.g. the applicant's own European patent applications EP 2 011 617, EP 2 078 602 and EP 2 082 986. Preferably, the inner bag is blow moulded together with and inside the outer container to its final volume, separated from the outer container and then collapsed by means or vacuum suction of the pressure space and/or injection of beverage into the beverage space.

According to a further embodiment of the first aspect, the inner bag comprises a first foil and a second foil, the first foil defining an inner upper edge, an opposite inner lower edge, a first side edge and an opposite second side edge welded to the first side edge, the second foil defining an outer upper edge being welded to the inner upper edge forming a common upper edge, an outer lower edge welded to the inner lower edge forming a common lower edge, a third side edge and an opposite fourth side edge welded to the third side edge, the inner bag defining the pressure space between the first foil and the second foil. According to a preferred embodiment, the enclosed space being separated into at least three internal spaces by joints, preferably welds, glues or stitching, extending partially between the common upper edge and the common lower edge.

According to a further embodiment of the first aspect, the cap comprises a pressure fluid passage for establishing fluid communication between the pressure space and the outside of the container assembly, the beverage passage and the pressure fluid passage being separated. The pressure fluid passage will be used for pressurizing the inner bag from the outside for providing the dispensing pressure for the beverage. Typically, the present beverage container assembly will be used together with a beverage dispensing system having a keg connector which may comprise a pressure fluid duct for connecting the pressure fluid passage to a pressure source, and a beverage duct for connecting the beverage passage to a tapping unit. The pressure fluid is typically a gas. Most preferably air is used; however, other gasses may be used, such as CO2 or N2. The pressure space may thus be omitted and the beverage container may be held in a temperature controlled room, e.g. a cellar. Pass-through cooling may be used in the beverage duct in order to reduce the temperature of the beverage to an appropriate drinking temperature.

According to a further embodiment of the first aspect, the inner bag is filled by an adsorption material, such as activated carbon, having adsorbed a specific amount of adsorption gas, such as CO₂. Alternatively, the beverage container assembly may be self-contained, i.e. include pressurization. In this way, the inner bag and thus the pressure space includes a propellant gas adsorbed in adsorption material. The gas adsorbed by the adsorption material is sufficient for substituting the complete beverage space. The inner bag is thus permanently sealed off by the cap. In order to safely removing the pressurization after complete dispensation of the beverage, a safety valve may be provided.

According to a further embodiment of the first aspect, the adsorption material is separated from the inner bag by a canister connected to the cap, the cap comprising a pressure fluid passage for establishing fluid communication between the canister and the pressure space. Alternatively to placing the adsorption material directly in the inner bag, the adsorption material may be placed in a canister within the inner bag. Preferably, the canister is connected to the cap and a pressure fluid passage is provided in order to separate the adsorption material from the rest of the inner bag. An activation mechanism may be provided which opens the pressure fluid channel upon activation by the user.

The above advantage, need and object together with numerous other advantages, needs and objects, which will be evident from the below detailed description, are according to a second aspect achieved by a preform assembly for manufacturing a beverage container assembly for holding a beverage, the preform assembly comprising:
an outer preform defining a body portion and a cylindrical neck portion connected to the body portion, the cylindrical neck portion defining a rim located opposite the body portion, and
an inner preform being sealed together with the outer preform at the rim of the cylindrical neck thereby defining a first space within the inner preform and a second space between the inner preform and the outer preform, the inner preform comprising a beverage conduit located adjacent the neck portion between the rim and the body portion of the outer preform for providing fluid communication between the second space and the outside of the preform assembly.

The beverage container according to the first aspect may be produced by using a preform according the second aspect.

According to a further embodiment of the first aspect, the preform assembly further comprises a cap for sealing off both the inner preform and the neck portion at a location between the rim and the body portion, the cap comprising a beverage passage for establishing fluid communication between the second space and the outside of the preform assembly, and a pressure fluid passage for establishing fluid communication between the first space and the outside of the preform assembly, the beverage passage and the pressure fluid passage being separated.

The preform according to the second aspect is preferably supplied together with the cap. The perform, which preferably is made of plastics, will be integrally blow moulded, filled and capped in order to form the beverage container assembly according to the first aspect.

The above advantage, need and object together with numerous other advantages, needs and objects, which will be evident from the below detailed description, are according to a second aspect achieved by a method of producing and filling a beverage container assembly comprising the steps of:
providing a preform assembly comprising an outer preform defining a body portion and a cylindrical neck portion connected to the body portion, the cylindrical neck portion defining a rim located opposite the body portion, the preform assembly further comprising an inner preform being sealed together with the outer preform at the rim of the cylindrical neck thereby defining a first space within the inner preform and a second space between the inner preform and the outer preform, the inner preform comprising a beverage conduit located adjacent the neck portion between the rim and the body portion of the outer preform for providing fluid communication between the second space and the outside of the preform assembly,
integrally blow molding the preform assembly to form a beverage container assembly by causing the inner preform to form an inner bag and the outer preform to form an outer container, thereby causing the first space to form a pressure space and the second space to form a beverage space,
filling beverage into the beverage space thereby compressing the inner bag, and
sealing off both the inner bag and the neck portion of the outer container at a location between the rim and the body portion, the cap comprising a beverage passage for establishing fluid communication between the beverage space and the outside of the beverage container assembly.

The method according to the third aspect is preferably used together with the preform according to the second aspect in order to form an assembly according to the first aspect. The beverage is filled between the outer keg and the inner bag preferably before applying the cap by directly accessing the beverage conduit with a filling hose, or alternatively after capping by introducing the beverage through the beverage passage.

The above advantage, need and object together with numerous other advantages, needs and objects, which will be evident from the below detailed description, are according to a fourth aspect achieved by a method of dispensing beverage by providing a beverage container assembly, the beverage container assembly comprising:
an outer container defining a body portion and a cylindrical neck portion connected to the body portion, the cylindrical neck portion defining a rim located opposite the body portion,
an inner bag positioned within the outer container and defining a pressure space inside the inner bag and a beverage space between the inner bag and the outer container, the beverage space being filled by beverage, and
a cap sealing off both the inner bag and the neck portion at a location between the rim and the body portion, the cap comprising a beverage passage for establishing fluid communication between the beverage space and the outside of the container assembly, the method comprising the steps of causing pressurized gas to enter the pressure space thereby causing the inner bag to change from a compressed state in which the inner bag is folded to an expanded state in which the inner bag is unfolded and filled by a pressure fluid and causing the beverage to be dispensed from the beverage space via the beverage passage to the outside.

The method according to the fourth aspect is preferably used together with the preform according to the second aspect in order to form an assembly according to the first aspect by employing the method according to the third aspect. The beverage dispensing assembly is typically coupled to a keg connector which comprises a pressure fluid duct for connecting the pressure fluid passage to a pressure source, e.g. a compressor or gas bottle, and a beverage duct for connecting the beverage passage to a tapping unit, e.g. a beverage tap.

### BRIEF DESCRIPTION OF THE DRAWINGS

FIG. 1A is a beverage container assembly within a packaging box

FIG. 1B is a beverage container assembly within a packaging box during dispensing

FIG. 2B is a preform assembly

FIG. 3 is a cap assembly.

FIG. 4A is a top view of a cap assembly

FIG. 4B is a side view of a cap assembly

FIG. 5 is a close-up view of the neck portion of the preform assembly

FIG. 6 is a close-up view of the blow moulding of the preform assembly

FIG. 7A is a beverage container assembly during filling

FIG. 7B is a close-up view of the neck portion during filling

FIG. 8A is a beverage container assembly filled by beverage

FIG. 8B is a close-up view of the neck portion after filling

FIG. 9A is a beverage container assembly after activation

FIG. 9B is a close-up view of the neck portion after activation

FIG. 10A is a beverage container assembly during dispensing

FIG. 10B is a close-up view of the neck portion during dispensing

FIG. 11 is a perspective view of a beverage dispensing assembly

FIG. 12A is an alternative embodiment of a beverage container assembly

FIG. 12B is a close-up view of the neck portion of the alternative embodiment

FIG. 13A is an alternative embodiment of a beverage container assembly during dispensing

FIG. 13B is a top view of the alternative embodiment during dispensing

FIG. 14A is an alternative embodiment of a beverage container assembly after dispensing

FIG. 14B is a top view of the alternative embodiment after dispensing

FIG. 15A is a side view of a self-contained beverage dispenser during mounting

FIG. 15B is a side view of a self-contained beverage dispenser during filling

FIG. 15C is a side view of a self-contained beverage dispenser after filling

FIG. 15D is a side view of a self-contained beverage dispenser during dispensing

FIG. 16A-D is a series of views of an alternative embodiment similar to FIG. 15A-D.

### DETAILED DESCRIPTION OF THE DRAWINGS

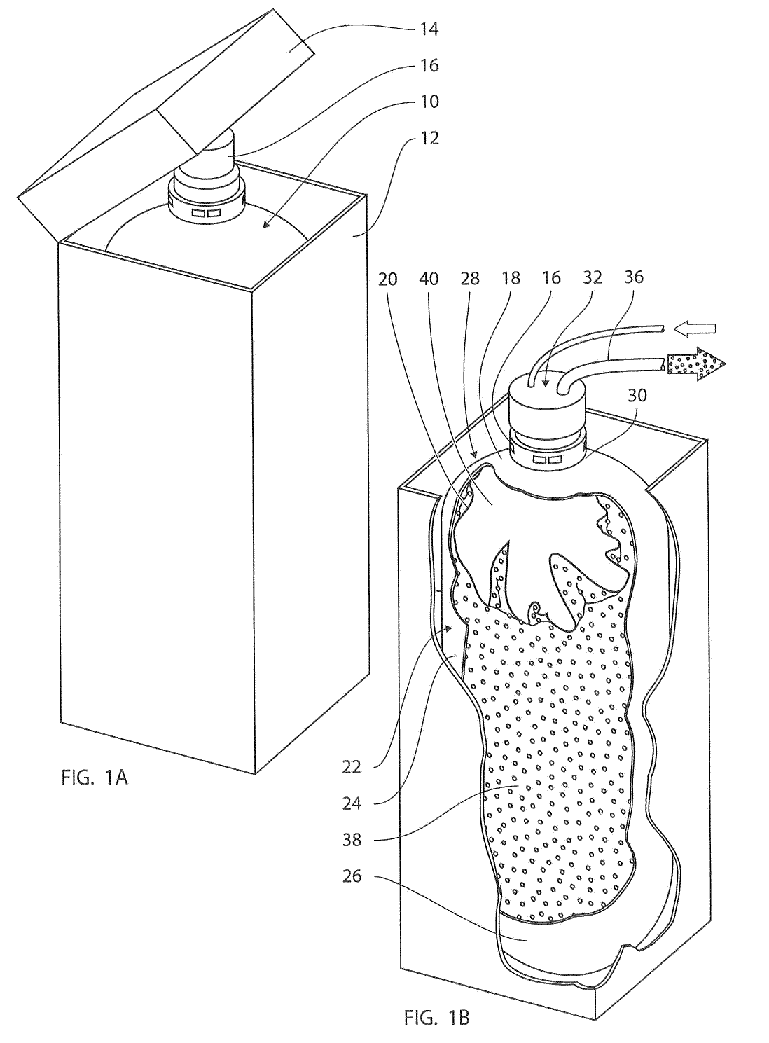

FIG. 1 shows a perspective view of a beverage container assembly (10) positioned within a packaging box (12). The packaging box (12) comprises a lid (14) which is closing off the packaging box (12) during shipping and handling. The packaging box (12) and the lid (14) may preferably be made of a recyclable material such as paper board. Before beverage dispensing the lid (14) is removed thereby revealing a base part (16) of the beverage container assembly (10). The beverage container assembly (10) may remain within the packaging box (12) during beverage dispensing in order for the beverage container assembly (10) to be kept in a stable and secure position.

FIG. 1B shows a perspective cut-out view of a beverage container assembly (10) within a packaging box (12) during beverage dispensing. The beverage container assembly (10) comprises an outer container (18) and an inner bag (20) which are preferably integrally blow moulded from a plastic preform. The outer container (18) is typically made sufficiently rigid to support its own weight, whereas the inner bag (20) should be made sufficiently flexible to be capable of folding and unfolding within the outer container (18). The container assembly (10) defines a body portion (22) which comprises the major part of the beverage container assembly (10). The body portion (22) in the present embodiment defines a cylindrical side (24), a conical bottom (26) and conical top (28). The conical top (28) comprises a cylindrical neck portion (30). The neck portion (30) is closed off by the base part (16). In order to extract beverage from the beverage container assembly (10) a keg connector (32) is connected to the base part (16) on the neck portion (30) of the beverage container assembly (10). The keg connector (32) comprises a pressure line (34) and a beverage line (36). The beverage is stored in a beverage space (38) which is disposed between the outer container (18) and the inner bag (20). The beverage space (38) is connected to the beverage line (36) via the base part (16). The fluid inlet (34) is connected to a pressure space (40) via the base part (16). The pressure space (40) is disposed within the inner bag and completely separated from the beverage space (38). The pressure line (34) is connected to a pressure source (not shown) which in the present case is a gas pressure source and which pressurizes the pressure space (40) within the inner bag (20). The inner bag (20) thus subjects the beverage space (38) to a dispensing pressure. The beverage line (36) is connected to a beverage tap (not shown) optionally via a safety valve (not shown) and/or a pass-through cooling system (not shown). As the beverage is being dispensed by operating the beverage tap (not shown), the beverage flows from the beverage space (38) in the direction of the beverage filled arrow, whereas pressure fluid flows in the direction of the pressure fluid arrow into the inner bag (20) which consequently expands by unfolding.

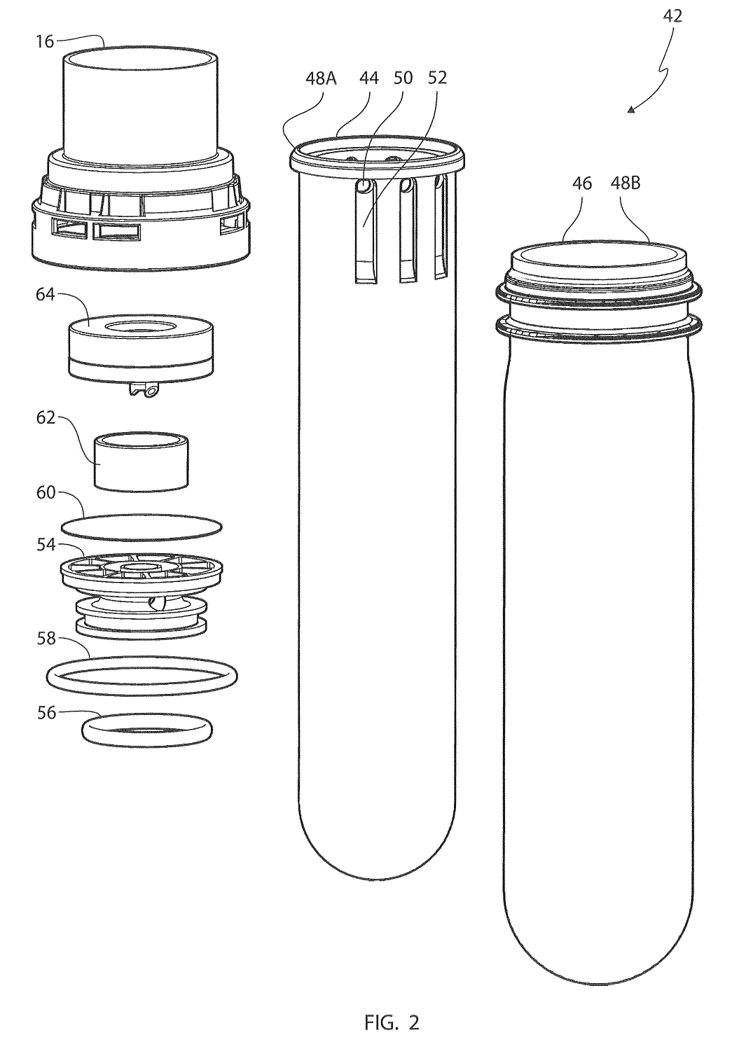

FIG. 2 shows a perspective view of a preform assembly (42). The preform assembly (42) comprises an inner preform (44) which is suitable to be disposed within an outer preform (46). The inner preform (44) comprises a rim (48A) which may sealingly engage a rim (48B) on the outer preform (46) to form a unitary rim. The inner preform (44) further comprises a number of beverage conduits (50) in the form of openings located adjacent the rim (48A) and a corresponding number of beverage channels (52) extending on the outside of the inner preform (44) from the beverage conduit (50) and in a direction opposite the rim (48A). The preform assembly (42) is closed off by a cap assembly. The cap assembly comprises an inner sealing member (56), an outer sealing member (58), a cap (54), a rupturable seal (60), a connecting member (62), a piercing member (64) and finally a base part (16). These elements will be discussed in detail below.

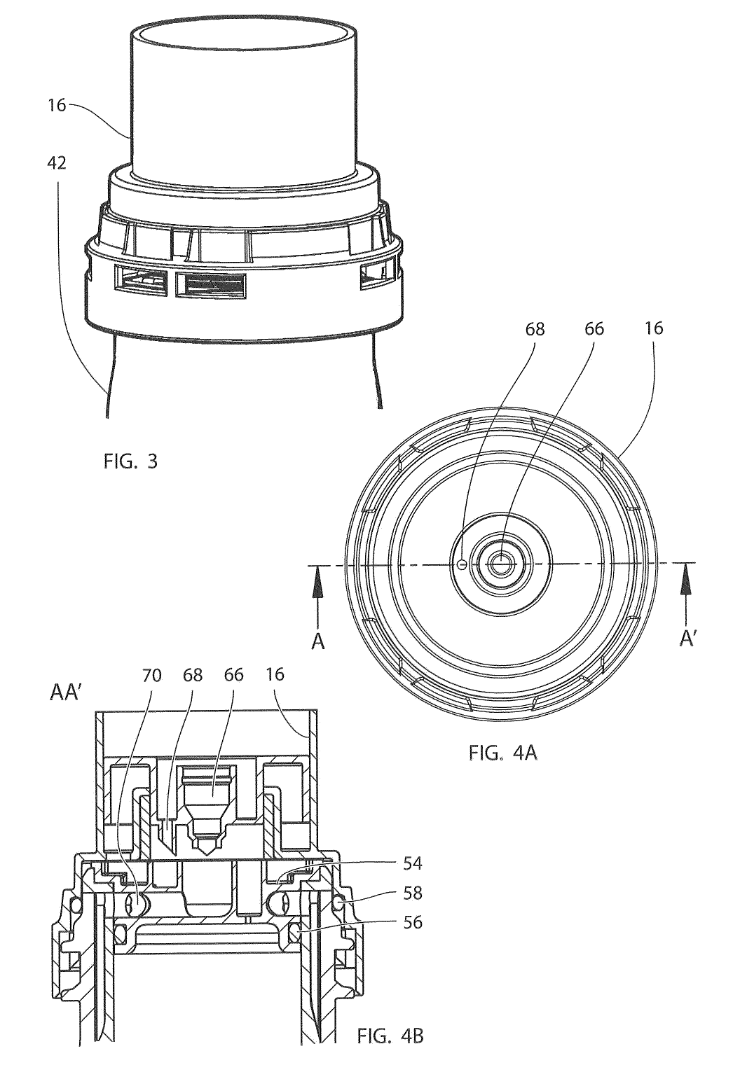

FIG. 3 shows a perspective view of a base part (16) when mounted on top of a rim (not shown) of a preform assembly (42). The base part (16) is adapted to connect and establish fluid communication with a keg connector (not shown).

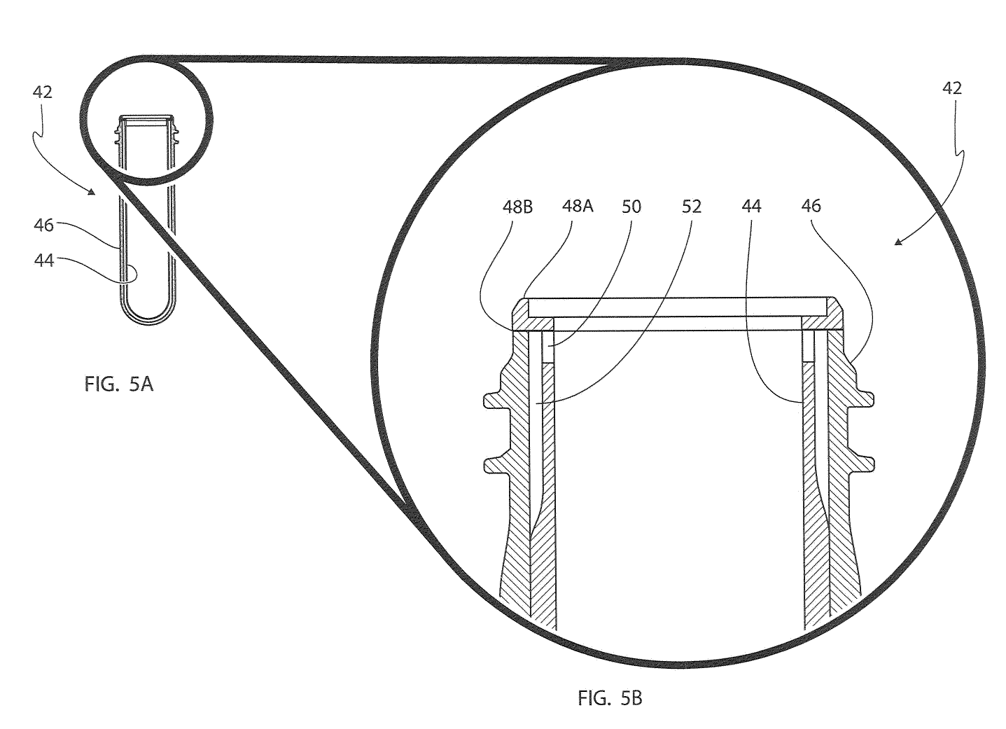

FIG. 4A shows a top view of a cap assembly. The cap assembly defines a beverage passage (66) centrally located in the cap assembly and a pressure fluid passage (68) located spaced apart from the beverage passage (66) and separated therefrom.

FIG. 4B shows a side cut-out view of a cap assembly along the line A-A′ of FIG. 4A. Notably the pressure fluid passage (68) extends from the inside of the inner preform to the outside of the preform assembly (42) through the cap (54), whereas the beverage passage (56) extends through the cap (54) and establishes fluid communication from the space in-between the inner preform (44) and the outer preform (46) via the beverage conduit (50) and a circumferential cavity (70) in the cap (54) to the outside of the preform assembly (42). The cap (54) seals off both the inner preform (44) via the inner sealing member (56) and the outer preform (46) via the outer sealing member (58) such that the above-mentioned pressure fluid passage (68) and beverage passage (66) are separated.

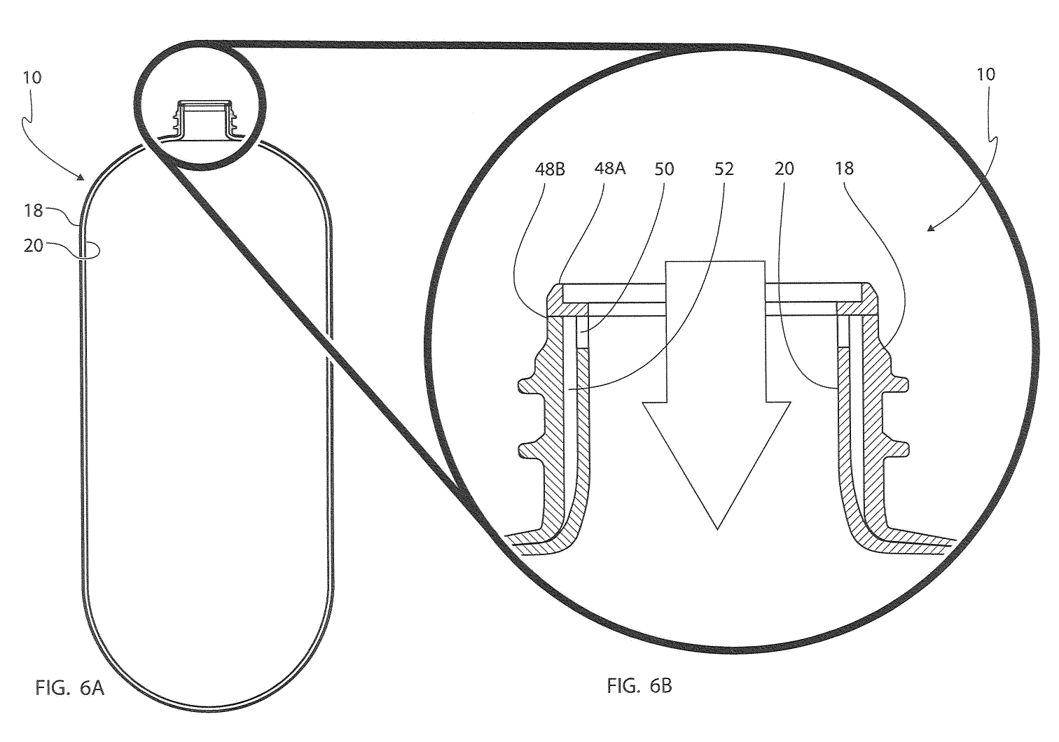

FIG. 5A shows a side view of a preform assembly (42).

FIG. 5B shows a close-up side view of the neck portion of the preform assembly (42). It can be seen that the rim (42A) of the inner preform (44) and the rim (42B) of the outer preform (46) are sealed together and that the beverage conduit (50) is established adjacent the rim (48) of the preform assembly (42).

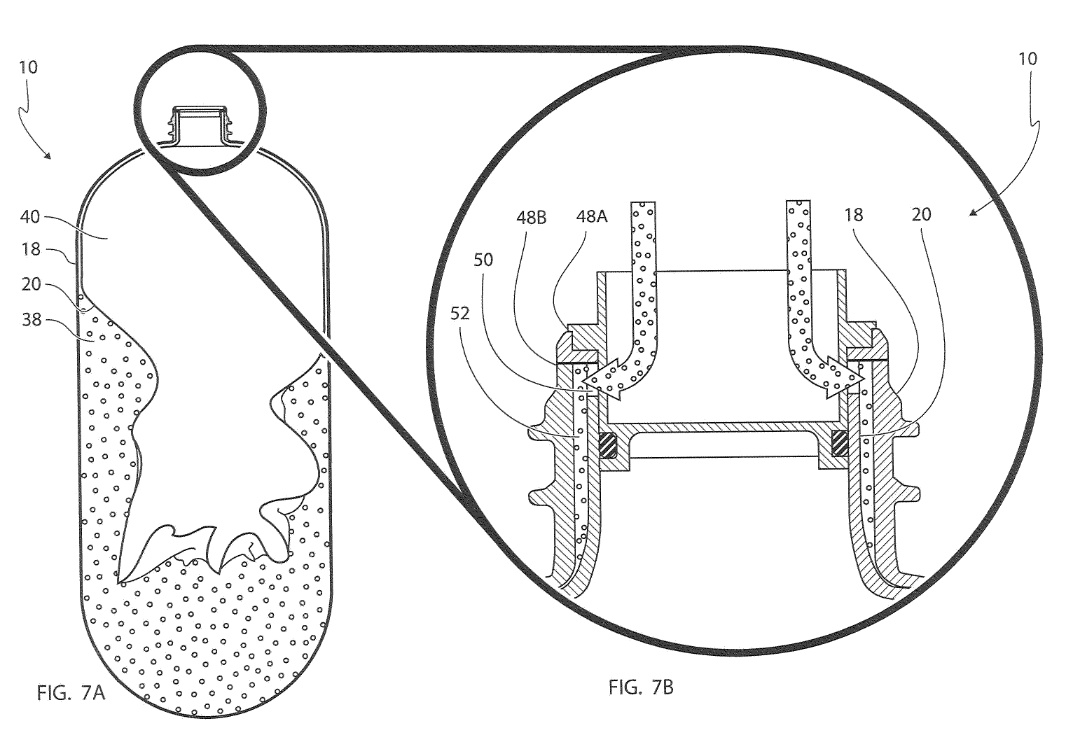

FIG. 6A shows a side view of a beverage container assembly (10).

FIG. 6B shows a side close-up view of the neck portion of the preform assembly after blow moulding. The inner preform and the outer preform are integrally blow moulded into a beverage container assembly (10).

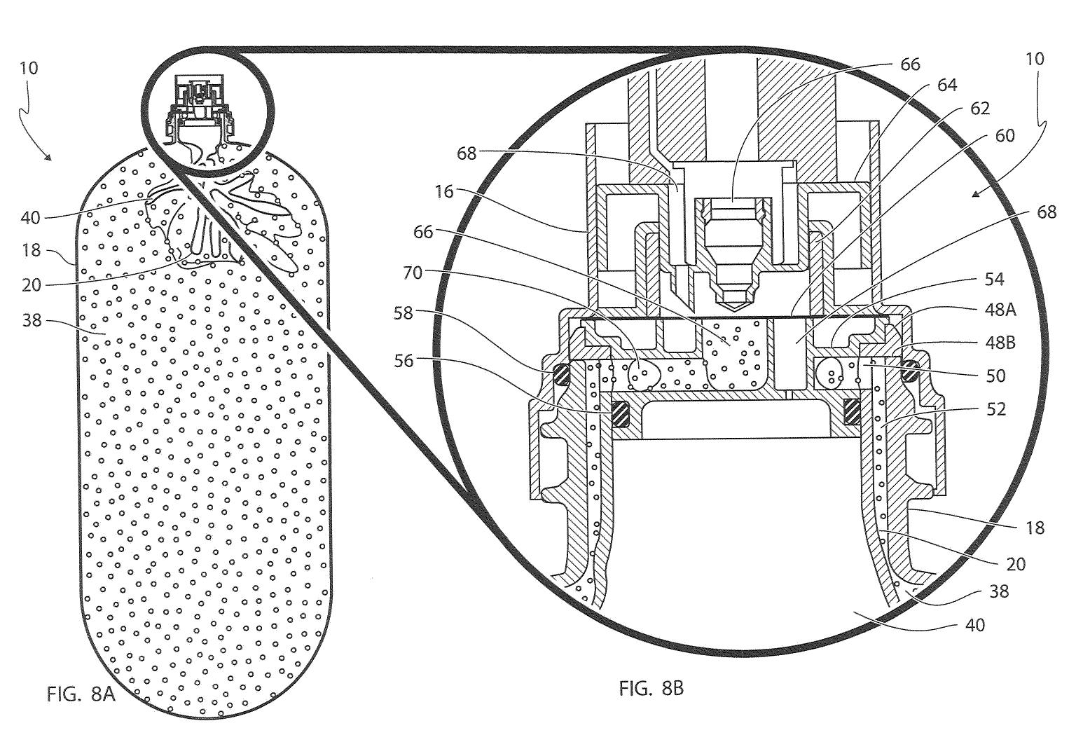

FIG. 7A shows a beverage container assembly (10) during filling. During filling beverage is introduced into the beverage space (38) in-between the inner bag (20) and the outer container (18) thereby compressing the pressure space (40) and folding the inner bag (20).

FIG. 7B shows a side close-up view of the filling of the beverage container assembly (10). The beverage is introduced directly into the beverage conduit (50) of the inner bag (20). The beverage is thereby prevented from entering the pressure space (40). Filling may be made having the cap assembly mounted, however, preferably the filling is made when the cap assembly is dismounted.

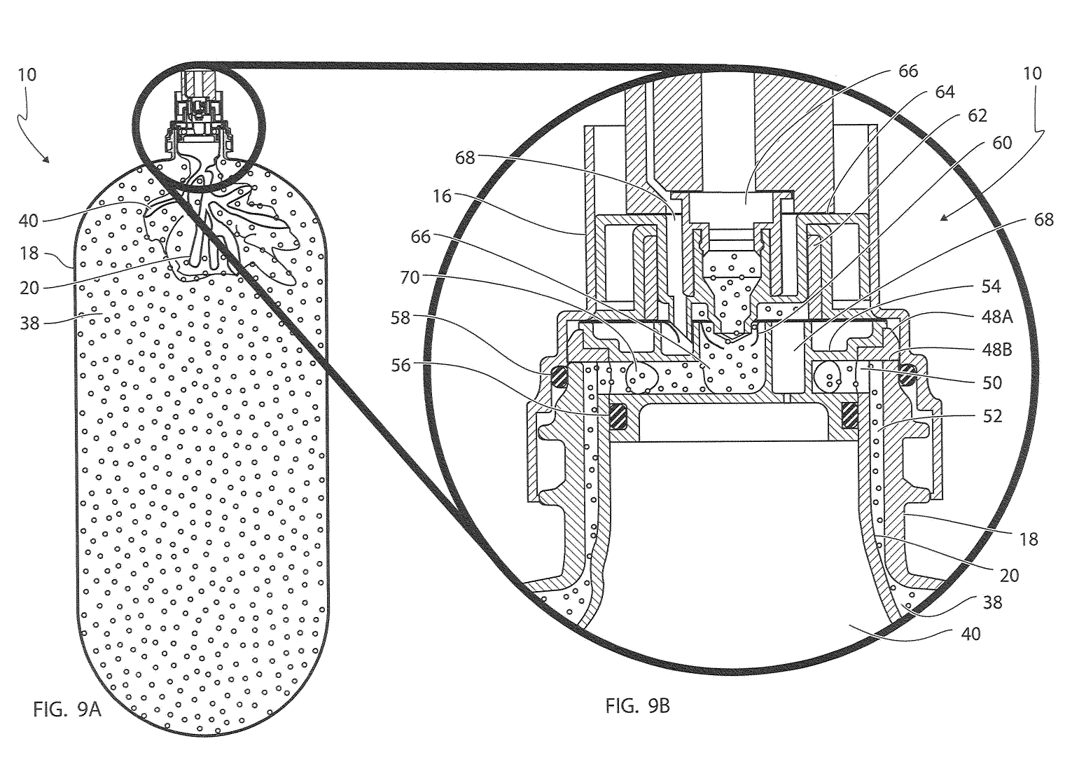

FIG. 8A shows a side view of a beverage container assembly (10) which has been filled by a beverage. The inner bag (20) has been folded and is located adjacent the neck part of the beverage container assembly (10).

FIG. 8B shows a side close-up view of a beverage container assembly (10) which has been filled by a beverage. The cap (54) closes off the pressure space (40) apart from the pressure fluid passage (68) which is closed off by the rupturable seal (60). The cap (54) also closes off the beverage passage (66) together with the rupturable membrane (60).

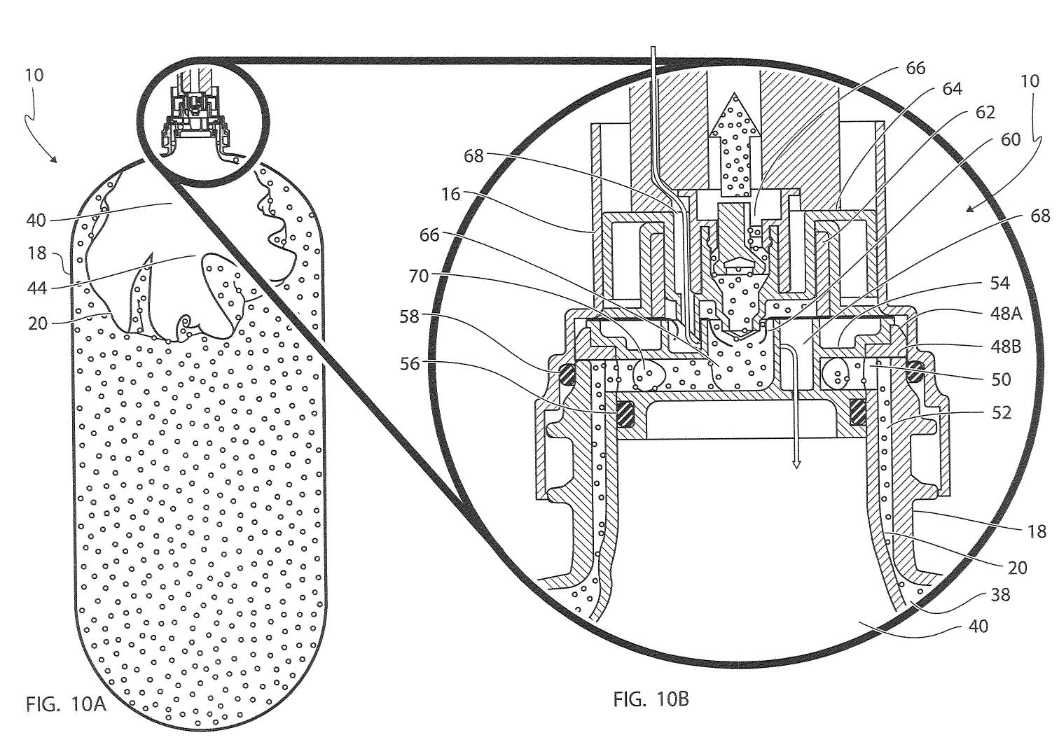

FIG. 9A is essentially identical to FIG. 8A.

FIG. 9B shows the neck part of the beverage container assembly (10) when the rupturable membrane (60) has been pierced by the piercing member (64). Beverage dispensing is enabled by activating the beverage container assembly (10). This is done by pushing the piercing member (64) towards the rupturable seal (60) thereby compressing the flexible connecting member (62) and causing the piercing member (64) to rupture the rupturable seal (60) at the location of the beverage passage (66) and pressure fluid passage (68).

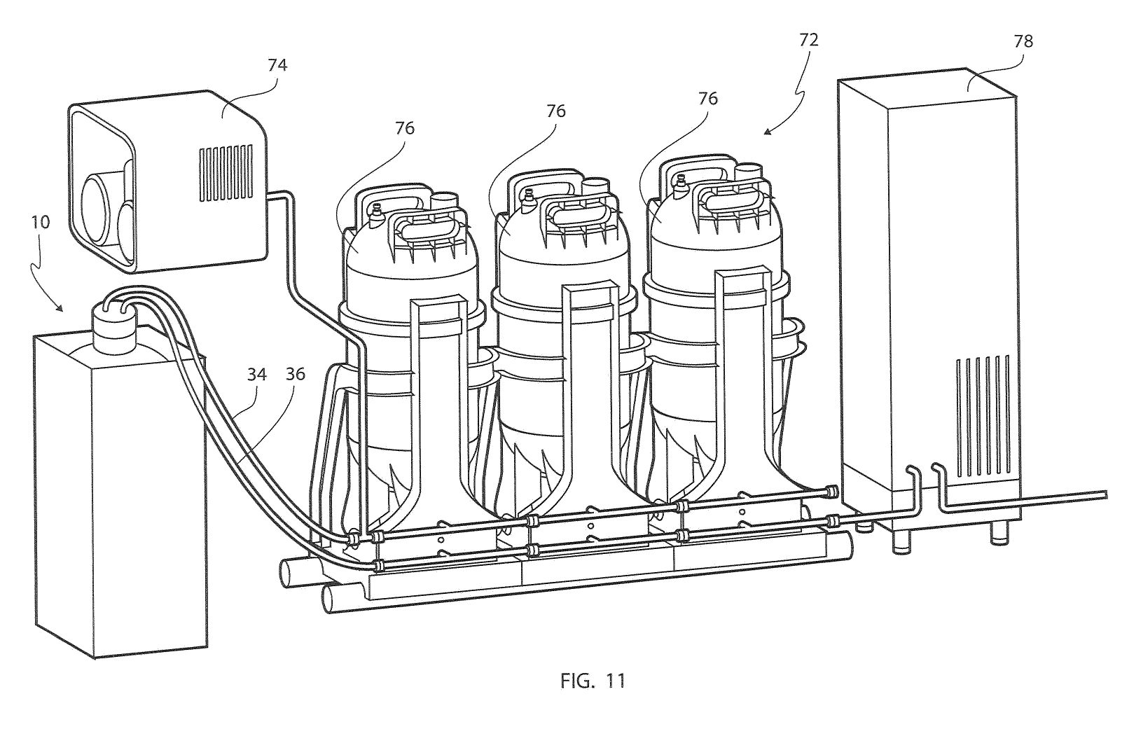

FIG. 10A shows a beverage container assembly (10) during beverage dispensing. During beverage dispensing the inner bag (20) unfolds and expands as the pressure space (40) is filled by pressure fluid and the volume of the beverage space (38) is reduced when beverage is dispensed.

FIG. 10B shows a close-up view of the neck portion of the beverage container assembly (10) during beverage dispensing. Pressure fluid is introduced through the pressure fluid passage (68) into the pressure space (40) defined by the inner bag (20) and beverage is dispensed from the beverage space (38) situated between the outer container (18) and the inner bag (20) via the beverage conduit (50) and the cavity (70) to the beverage passage (66) to the outer beverage container assembly (10).

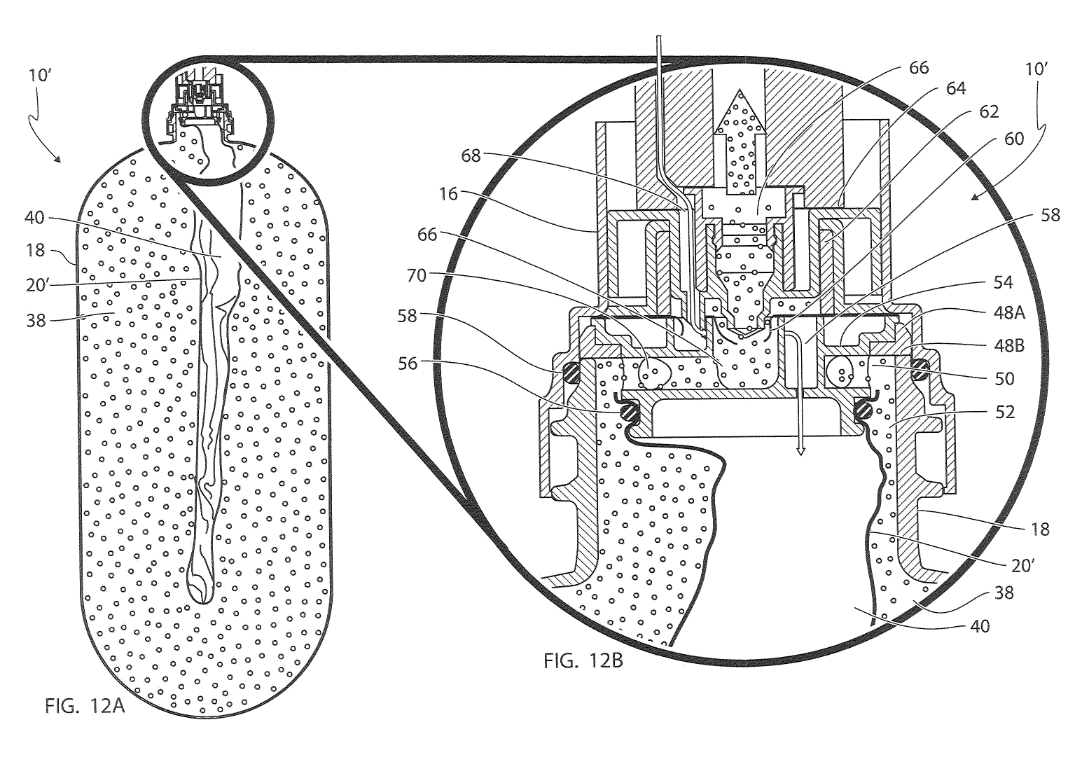

FIG. 11 shows a perspective view of a beverage dispensing assembly (72). The beverage dispensing assembly (72) comprises a pressure source (74) for pressurizing three standard pressure chambers (76) and in addition pressurizing the beverage container assembly (10) via the pressure fluid line (34). The beverage container assembly (10) is further connected via the beverage line (36) to the same beverage line as the pressure chambers (76) and further via a pass-through cooling system to a beverage tap (not shown). It should be noted that in the present beverage dispensing assembly (72) the pressure chambers (74) and the beverage container assembly (10) are connected in series, however, it is equally feasible to connect them in parallel to different beverage taps (not shown) or any other configuration readily conceivable by the person skilled in the art.

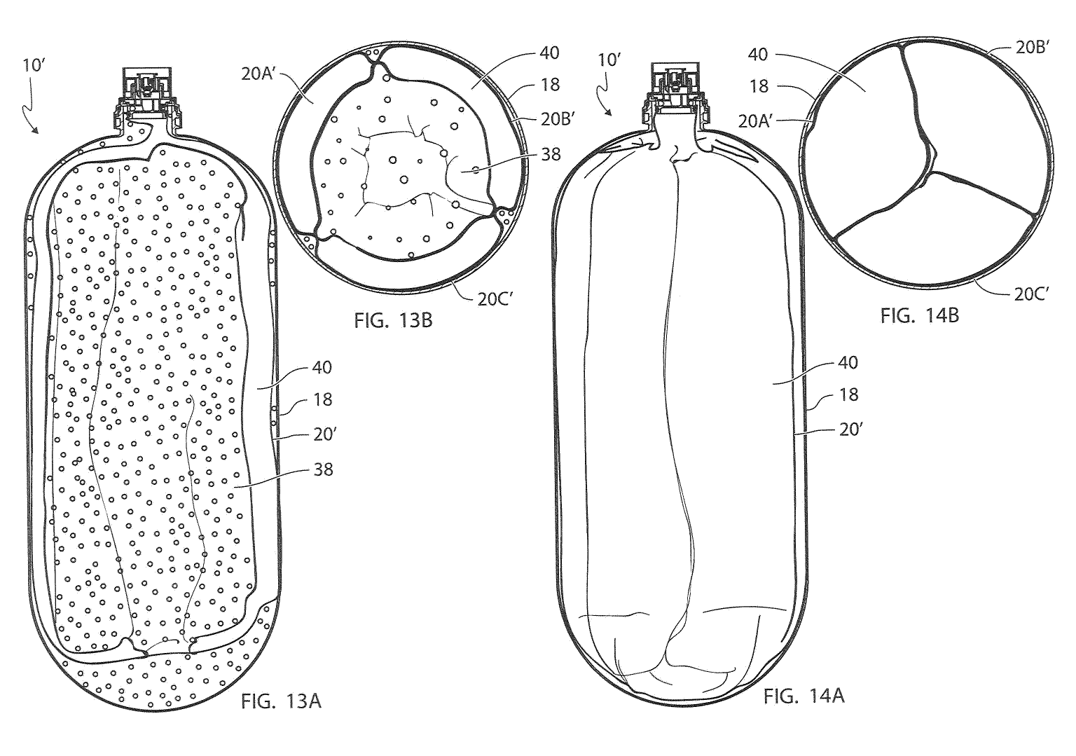

FIG. 12A shows a side view of an alternative embodiment of a beverage container assembly (10′). The present beverage container assembly (10′) is identical to the previous beverage container assembly except that the inner bag (20′) is not integrally blow moulded together with an outer container (18), but instead the inner bag (20) constitutes the separate component which is sealed onto the cap (54). The bag is formed by two cylindrical layers of plastic which have been soldered together along its edges.

FIG. 12B shows a close-up view of the neck portion of the alternative beverage container assembly (10′).

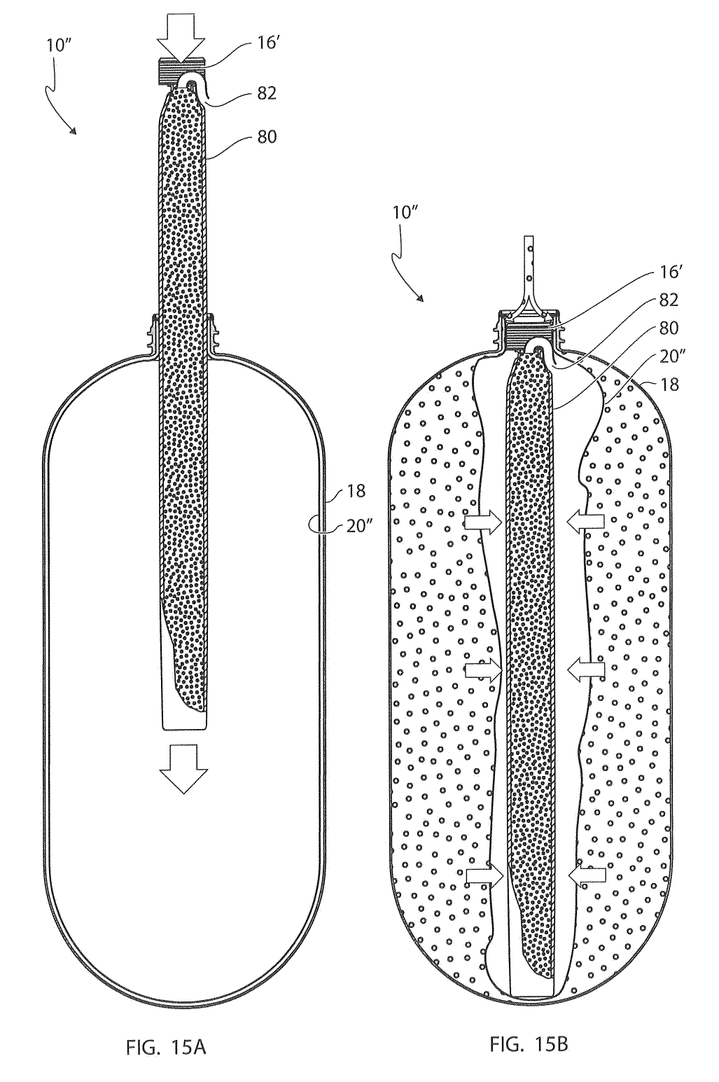

FIG. 13A shows the alternative embodiment of the beverage container assembly (10′) when the inner bag (20′) has been folded out.

FIG. 13B shows a top view of the alternative embodiment of the beverage container assembly (10′) during dispensing. It can be seen that the inner bag (20) in the present embodiment comprises three bag elements (20′A, 20′B and 20′C).

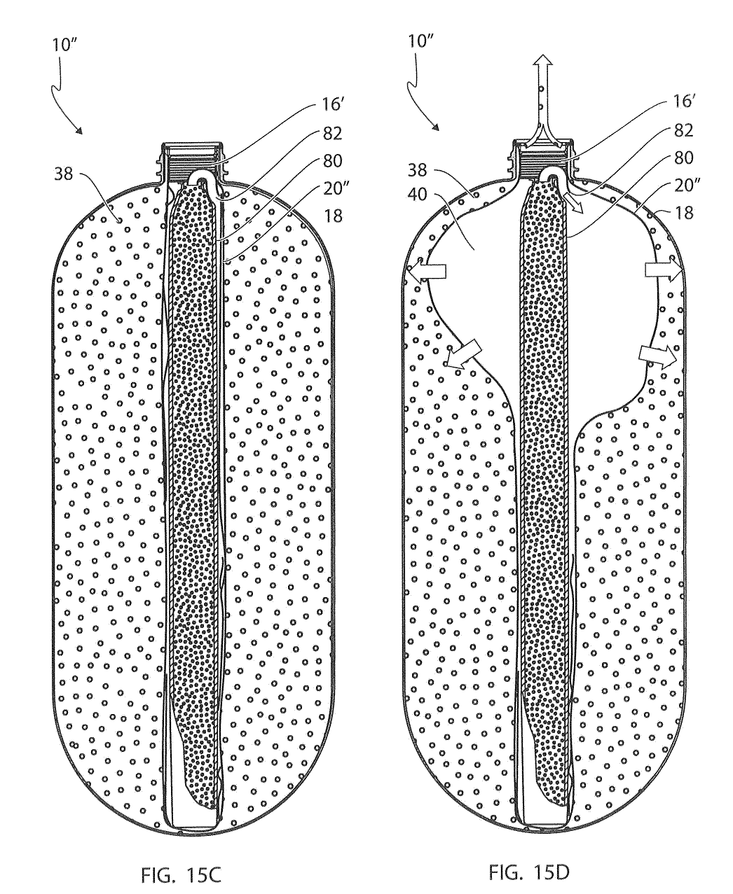

FIG. 14A shows the alternative embodiment of the beverage container assembly (10′) of the beverage dispensing. After beverage dispensing the inner bag (20) constituting the pressure space has substituted the beverage space (38).

FIG. 14B shows the alternative embodiment of the beverage container assembly (10′) in a top view after beverage dispensing. The three bags (20A, 20B, 20C) have fallen out and expanded adjacent the outer container (18), thus leaving a central beverage passage between the bags.

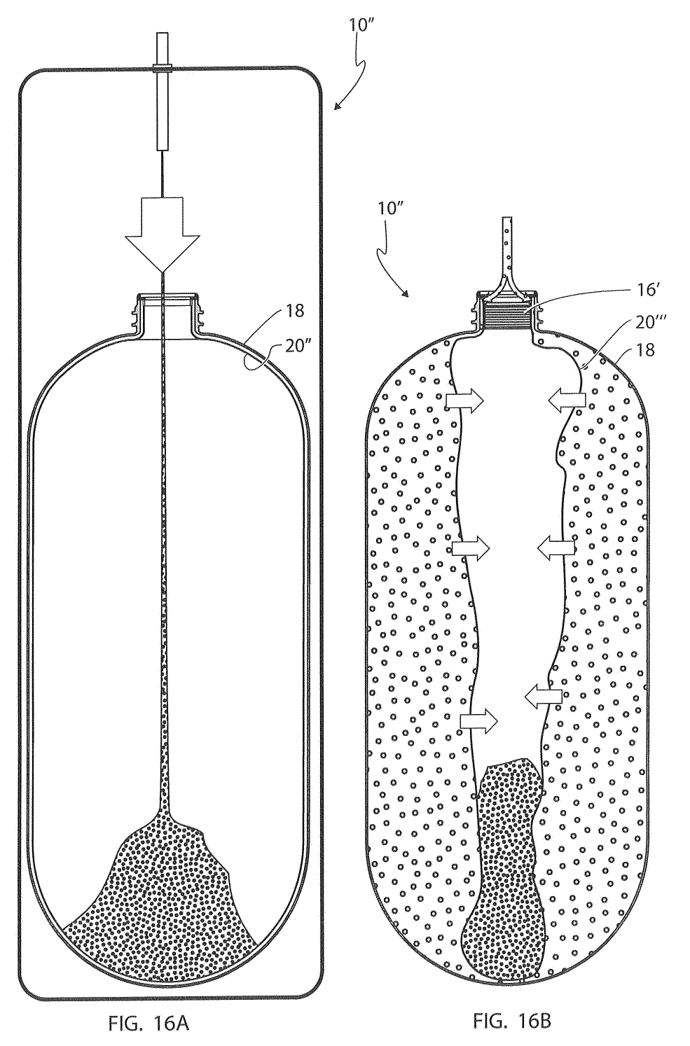

FIG. 15A shows a side view of a self-contained beverage container assembly (10″). The present embodiment is very similar to the first embodiment of the beverage container assembly (10) except that it includes a canister (80) filled with pressure fluid which has been adsorbed in an adsorption material. Preferably, the pressure fluid is carbon dioxide and the adsorption material is activated carbon. The cap (16′) comprises a gas passage (82) interconnecting the canister (80) and the inner bag (20″) outside the canister (80).

FIG. 15B shows a self-contained beverage container assembly (10″) during beverage filling. Beverage is filled in the beverage space between the inner bag (20″) and the outer container (18) thereby compressing the inner bag (20″) about the canister (80). The pressure space is thereby evacuated via the pressure fluid passage (68) of the cap (16′), whereas the gas passage (82) should be temporarily closed off.

FIG. 15C shows the self-contained beverage container assembly (10″) when the beverage space (38) has been completely filled by beverage. In this position the gas passage (82) is opened and the beverage passage is sealed off, whereas the pressure fluid passage is permanently sealed off.

FIG. 15D shows a self-contained beverage container assembly (10″) during dispensing. During dispensing the beverage flows out via the beverage passage (66), whereas the pressure fluid substituting the beverage space (38) flows from the canister (80) via the gas passage (82) into the pressure space (40) within the inner bag (20). The canister (80) includes sufficient pressure fluid to completely substitute beverage space (38).

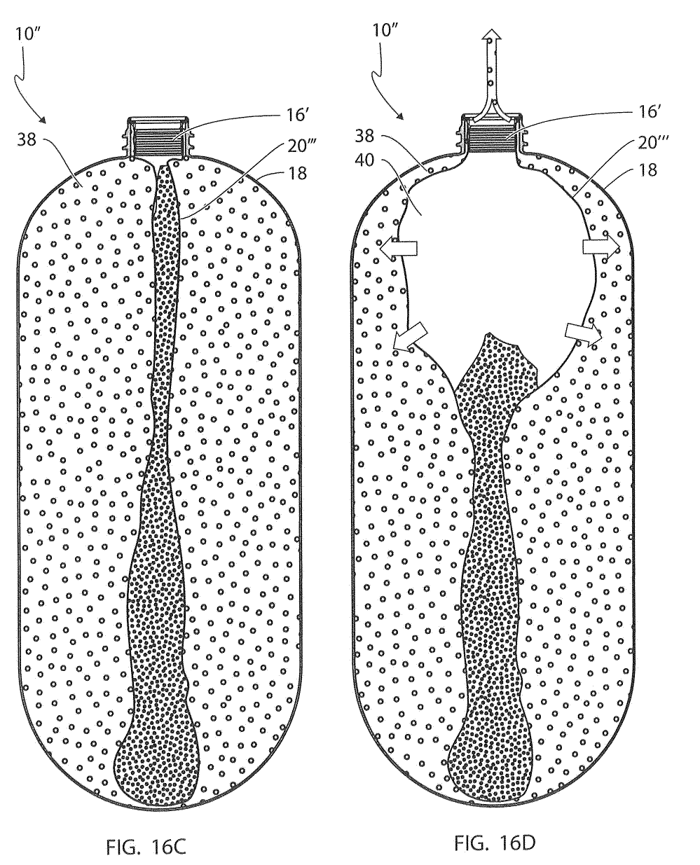

FIGS. 16A to 16D show a similar embodiment to the FIGS. 15A to 15D, however, the canister has been omitted and the adsorption material including the pressure fluid has been directly inserted into the inner bag (20). The filling of the present container is preferably made in a pressurized carbon dioxide atmosphere.

### REFERENCE NUMERALS

10. Beverage container assembly

12. Packaging box

14. Lid

16. Base unit

18. Outer container

20. Inner bag

22. Body

24. Side

26. Bottom

28. Top

30. Neck

32. Keg connector

34. Pressure fluid line

36. Beverage line

38. Beverage space

40. Pressure space

42. Preform assembly

44. Inner preform

46. Outer preform

48. Rim

50. Beverage conduit

52. Channels

54. Cap

56. Inner sealing ring

58. Outer sealing member

60. Rupturable seal

62. Connecting member

64. Piercing member

66. Beverage passage

68. Pressure fluid passage

70. Cavity

72. Beverage dispensing assembly

74. Pressure source

76. Pressure chambers

78. Pass-through cooling system

80. Canister

82. Gas passage

1. A beverage container assembly for holding a beverage, said beverage container assembly comprising:
an outer container defining a body portion and a cylindrical neck portion connected to said body portion, said cylindrical neck portion defining a rim located opposite said body portion;
an inner bag positioned within said outer container and defining a pressure space inside said inner bag and a beverage space between said inner bag and said outer container, said beverage space being filled by said beverage, said inner bag initially defining a folded state in which said inner bag is compressed and by subjecting said inner bag to a pressure fluid said inner bag being capable of expanding into an unfolded state in which said pressure space at least partially substitutes said beverage space; and
a cap sealing off both said inner bag and said neck portion at a location between said rim and said body portion, said cap comprising a beverage passage establishing fluid communication between said beverage space and the outside of said container assembly.

2. The beverage container assembly according to claim 1, wherein said inner bag and said outer container are sealed together along said rim of said cylindrical neck.

3. The beverage container assembly according to claim 2, wherein said inner bag comprises a beverage conduit located adjacent said neck portion between said rim and said body portion of said outer container, said beverage conduit providing fluid communication between said beverage space and said beverage passage.

4. The beverage container assembly according to claim 3, wherein said inner bag comprises a channel extending on the outside of said inner bag between said beverage conduit and said body portion of said container.

5. The beverage container assembly according to claim 3, wherein said beverage conduit comprises a plurality of openings of said inner bag, said openings being circumferentially distributed about said inner bag adjacent said neck portion between said rim and said body portion of said outer container.

6. The beverage container assembly according to claim 2, wherein said cap comprises a circumferential groove providing fluid communication between said beverage conduit and said beverage passage.

7. The beverage container assembly according to claim 2, wherein said outer container and said inner container are integrally blow molded from a preform assembly comprising an inner preform and an outer preform in a nested configuration.

8. The beverage container assembly according to claim 1, wherein said inner bag comprises a first foil and an second foil, said first foil defining an inner upper edge, an opposite inner lower edge, a first side edge and an opposite second side edge welded to said first side edge, said second foil defining an outer upper edge being welded to said inner upper edge forming a common upper edge, an outer lower edge welded to said inner lower edge forming a common lower edge, a third side edge and an opposite fourth side edge welded to said third side edge, said inner bag defining said pressure space between said first foil and said second foil.

9. The beverage container according to claim 1, wherein said cap comprises a pressure fluid passage establishing fluid communication between said pressure space and the outside of said container assembly, said beverage passage and said pressure fluid passage being separated.

10. The beverage container assembly according to claim 1, wherein said inner bag is filled by an adsorption material having adsorbed a specific amount of adsorption gas.

11. The beverage container assembly according to claim 10, wherein said adsorption material is separated from said inner bag by a canister connected to said cap, said cap comprising a pressure fluid passage establishing fluid communication between said canister and said pressure space.

12. A preform assembly for manufacturing a beverage container assembly for holding a beverage, said preform assembly comprising:
an outer preform defining a body portion and a cylindrical neck portion connected to said body portion, said cylindrical neck portion defining a rim located opposite said body portion, and
an inner preform being sealed together with said outer preform at said rim of said cylindrical neck thereby defining a first space within said inner preform and a second space between said inner preform and said outer preform, said inner preform comprising a beverage conduit located adjacent said neck portion between said rim and said body portion of said outer preform for providing fluid communication between said second space and the outside of said preform assembly.

13. The preform assembly according to claim 12, wherein said preform assembly further comprises a cap sealing off both said inner preform and said neck portion at a location between said rim and said body portion, said cap comprising a beverage passage establishing fluid communication between said second space and the outside of said preform assembly, and a pressure fluid passage establishing fluid communication between said first space and the outside of said preform assembly, said beverage passage and said pressure fluid passage being separated.

14. A method of producing and filling a beverage container assembly comprising the steps of:
providing a preform assembly comprising an outer preform defining a body portion and a cylindrical neck portion connected to said body portion, said cylindrical neck portion defining a rim located opposite said body portion, said preform assembly further comprising an inner preform being sealed together with said outer preform at said rim of said cylindrical neck thereby defining a first space within said inner preform and a second space between said inner preform and said outer preform, said inner preform comprising a beverage conduit located adjacent said neck portion between said rim and said body portion of said outer preform for providing fluid communication between said second space and the outside of said preform assembly;
integrally blow molding said preform assembly to form a beverage container assembly by causing said inner preform to form an inner bag and said outer preform to form an outer container, thereby causing said first space to form a pressure space and said second space to form a beverage space;
filling beverage into said beverage space thereby compressing said inner bag; and
sealing off both said inner bag and said neck portion of said outer container at a location between said rim and said body portion, while establishing fluid communication between said beverage space and the outside of said beverage container assembly.

15. (canceled)

16. A method of dispensing beverage from a beverage container assembly comprising (i) an outer container defining a body portion and a neck portion connected to the body portion, the neck portion defining a rim located opposite the body portion; (ii) an inner bag positioned within the outer container and defining a pressure space inside the inner bag and a beverage space between the inner bag and the outer container, the beverage space being filled by beverage; and (iii) a cap sealing off the inner bag and the neck portion at a location between the rim and the body portion, the cap comprising a beverage passage establishing fluid communication between the beverage space and the outside of the container assembly;
the method comprising the steps of:
(a) causing pressurized gas to enter the pressure space, thereby causing the inner bag to change from a compressed state to an expanded state; and
(b) causing the beverage to be dispensed from the beverage space via the beverage passage to the outside of the container assembly in response to the change of the inner bag from the compressed state to the expanded state.
